(19) United States
(12) Patent Application Publication
(10) Pub. No.: US 2015/0358736 A1
(43) Pub. Date: Dec. 10, 2015

(54) MAGNET ASSEMBLY AND SPEAKER COMPRISING THE ASSEMBLY

(71) Applicant: Knowles IPC(M) Sdn. Bhd., Penang (MY)

(72) Inventors: Bing Wang, Beijing (CN); Hongbin Deng, Beijing (CN); Wei Yu, Beijing (CN)

(21) Appl. No.: 14/730,105

(22) Filed: Jun. 3, 2015

(30) Foreign Application Priority Data
Jun. 5, 2014 (CN) 201410246585.5

(51) Int. Cl. H04R 9/02

(52) U.S. Cl. CPC H04R 9/025

(57) ABSTRACT

The present invention discloses a magnet assembly for a speaker, the assembly comprising: a magnet conductive base plate; an inner magnet and at least one outer magnet, the inner magnet and the at least one outer magnet being arranged on the magnet conductive base plate side by side and being spaced to each other by a space; and an inner magnet conductive plate and at least one outer magnet conductive plate arranged on the inner magnet and at least one outer magnet respectively, wherein the magnet conductive plate is provided with at least one outer magnet stopper which abuts against the outer magnet to limit the displacement of the at least one outer magnet in at least one direction. The present invention also discloses a speaker comprising the magnet assembly.

### CROSS REFERENCE TO RELATED APPLICATIONS

This application claims priority to Chinese Patent Application No. 201410246585.5, filed Jun. 5, 2014, the disclosure of which is incorporated in its entirety by reference herein.

### BACKGROUND OF THE INVENTION

a. Field of the Invention

The present disclosure relates to the field of speaker, more particularly, to a magnet assembly for a speaker and a speaker comprising the magnet assembly.

b. Description of the Related Art

The speaker is a device for amplifying voice used widely in various applications, for example, in industrial and consumer applications. A typical speaker has a structure in which a coil is driven by alternating currents flowing through the coil to vibrate in a magnetic field so as to cause a vibration membrane connected to the coil to vibrate to create sound. In such a structure, a magnet assembly with a magnet is necessary. For example, the magnet assembly may comprise an inner magnet which in operation is located within the coil and an outer magnet which is in operation located outside the coil. It is very critical to maintain the magnets correctly at the desired locations in the structure. A small shift of the magnets may cause significant distortions or noises of signals.

### SUMMARY OF THE INVENTION

An object of the present invention is to provide a magnet assembly for a speaker, which can limit the position of the outer magnets correctly.

Another object of the present invention is to provide a speaker comprising the magnet assembly, which can prevent distortions or noises of signals due to displacement of the outer magnets.

The present invention may be implemented by the following embodiments.

In accordance with one aspect of the present invention, it provides a magnet assembly for a speaker, the assembly comprising a magnet conductive base plate, an inner magnet and at least one outer magnet, the inner magnet and the at least one outer magnet being arranged on the magnet conductive base plate side by side and being spaced to each other by a space. The assembly further comprises an inner magnet conductive plate and at least one outer magnet conductive plate arranged on the inner magnet and the at least one outer magnet, respectively, wherein the magnet conductive base plate is provided with at least one outer magnet stopper which abuts against the outer magnets to limit the displacement of the at least one outer magnet in at least one direction.

In an embodiment, the at least one outer magnet may comprise a first outer magnet and a second outer magnet arranged on two opposed sides of the inner magnet, the at least one outer magnet conductive plate comprising a first outer magnet conductive plate and a second outer magnet conductive plate arranged on the first outer magnet and the second magnet, respectively.

In an embodiment, the first outer magnet and the second outer magnet may be arranged symmetrically with respect to the inner magnet.

In an embodiment, the at least one outer magnet stopper may be arranged at least partly in the space between the inner magnet and the at least one outer magnet.

In an embodiment, the at least one outer magnet stopper may abut against the outer magnet on one side of the outer magnet facing the inner magnet.

In an embodiment, the at least one outer magnet stopper may abut against the outer magnet in at least two directions.

In an embodiment, the at least one outer magnet may have at least one contacting face which abuts against the outer magnet stopper and is arranged at a corner of the outer magnet towards the inner magnet.

In an embodiment, one or more contacting faces may be angled at a first direction in a plane parallel to the magnet conductive base plate, the first direction being a direction towards the inner magnet from the outer magnet on which the one or more contacting faces are located.

In an embodiment, the at least one contacting face may comprise a first contacting face and a second contacting face arranged at two different corners of the same outer magnet and not parallel to each other, the first contacting face and the second contacting face abutting against the different outer magnet stoppers, respectively.

In an embodiment, the at least one contacting face may comprise a first contacting face and a second contacting face arranged at the same corner of the same outer magnet and not parallel to each other, the first contacting face and the second contacting face abutting against the different outer magnet stoppers respectively or abutting against the same outer magnet stopper.

In an embodiment, the outer magnet stopper and the magnet conductive base plate may be integrated in one single part.

In accordance with another aspect of the present invention, it provides a speaker, comprising the magnet assembly according to any of the above embodiments, a coil arranged in the space between the outer magnets and the inner magnet and surrounding the inner magnet, a vibration membrane laid on the coil and above the inner magnet and the outer magnets, and a supporter connected to the magnet conductive base plate and configured to support the vibration membrane.

With the above aspects, the stopper is provided for the outer magnets to avoid the displacement of the outer magnet. The magnet assembly and speaker according to the present invention may prevent the distortions or noises of signals caused by relative displacement of the magnets.

### BRIEF DESCRIPTION OF THE DRAWINGS

FIG. 1 is a schematic top view showing a magnet assembly in accordance with an embodiment of the present invention.

FIG. 2 is a schematic perspective view of the magnet assembly shown in FIG. 1.

FIG. 3 is a schematic view showing position of the magnet assembly shown in FIG. 1 when it works along with a coil.

FIG. 4 is a schematic top view showing a magnet assembly in accordance with another embodiment of the present invention.

FIG. 5 is a schematic view showing a speaker in accordance with an embodiment of the present invention.

### DETAILED DESCRIPTION OF THE EMBODIMENTS

Technical solutions of the present invention will be described hereinafter in more detail by the way of embodiments with reference to accompanying drawings, wherein the same or like reference numerals refer to the same or like elements throughout the specification. The explanation the embodiments of the present invention with reference to the accompanying drawings is intended to interpret the general inventive concept of the present invention, rather than being construed as limiting to the present invention.

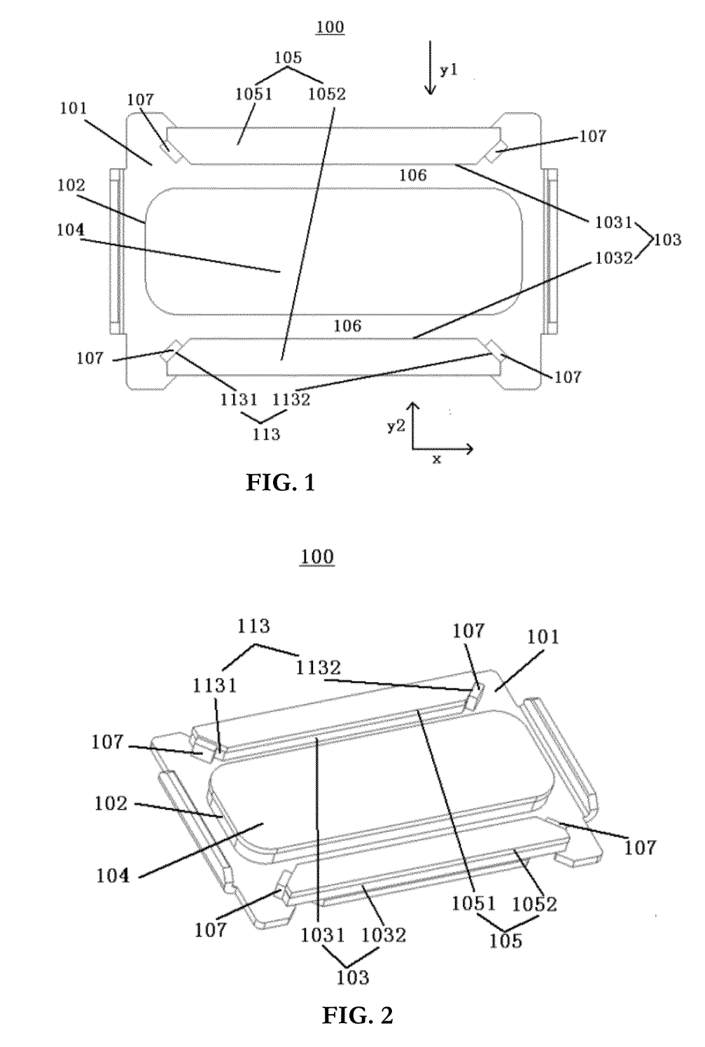

FIGS. 1-2 show schematically a magnet assembly 100 according to an embodiment of the present invention. The magnet assembly 100 may include a magnet conductive base plate 101 (also referred to as a magnet pot), an inner magnet 102, at least one outer magnet 103, an inner magnet conductive plate 104 and at least one outer magnet conductive plate 105. The inner magnet 102 and the outer magnet 103 may be arranged on the magnet conductive base plate 101 side by side. A space 106 is located between the inner magnet 102 and the at least one outer magnet 103. The inner magnet conductive plate 104 and the at least one outer magnet conductive plate 105 are arranged on the inner magnet 102 and the at least one outer magnet 103, respectively. At least one outer magnet stopper 107 is arranged on the magnet conductive base plate 101. The outer magnet stopper 107 abuts against the outer magnet 103 to limit the displacement of the at least one outer magnet 103 in at least one direction. As an example, the outer magnet 103 and the inner magnet 102 may be fixed on the magnet conductive base plate 101, for example, by welding or adhering. In an example, the outer magnet stopper 107 may resist the effects of certain external forces, for example, attracting forces of the inner magnet 102 to the outer magnet 103, gravity on the outer magnet 103 and so on, to the outer magnet 103. Thus, the outer magnet stopper 107 may effectively prevent the outer magnet 103 from displacing, even falling off. It is effective in particular if the connection between the outer magnet 103 and the magnet conductive base plate 101 is not very firm.

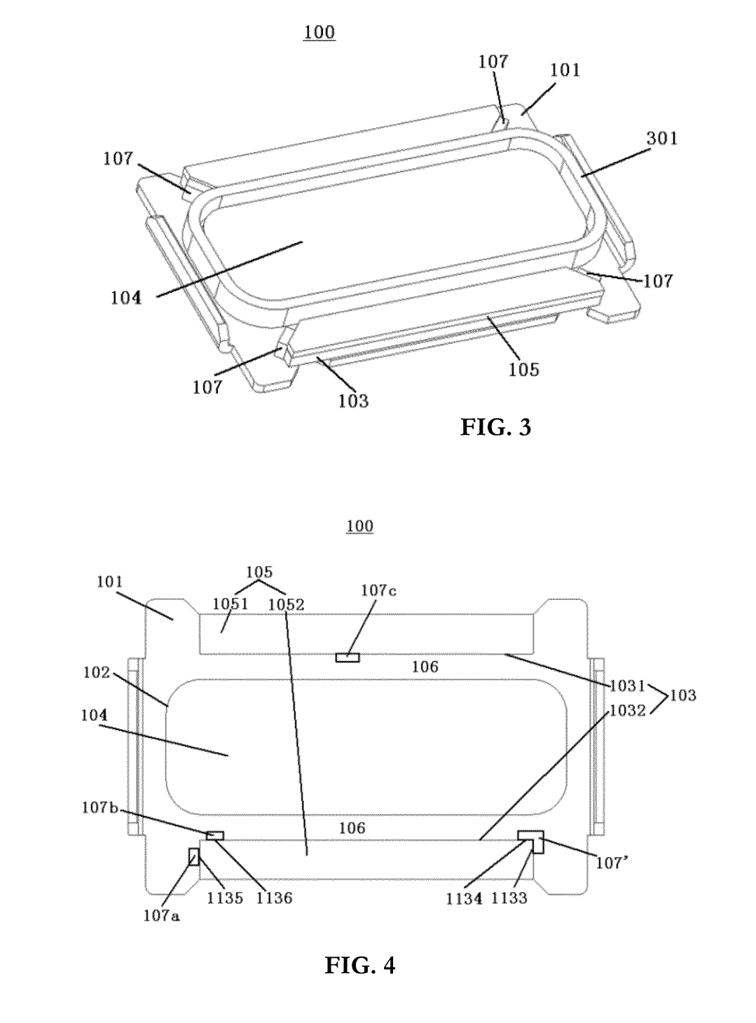

In the embodiment shown in FIGS. 1-3, a three-magnet assembly is provided, that is, one inner magnet 102 and two outer magnets 103 (a first outer magnet and a second outer magnet). The first outer magnet 1031 and the second outer magnet 1032 are arranged on two opposite sides of the inner magnet 102. A first outer magnet conductive plate 1051 and a second outer magnet conductive plate 1052 are arranged on the first outer magnet 1031 and the second outer magnet 1032, respectively. When the magnet assembly 100 works along with a coil 301, the inner magnet 102 is located inside the coil 301 and is surrounded by the coil 301, and the first outer magnet 1031 and the second outer magnet 1032 are located outside the coil 301. As an example, the first outer magnet 1031 and the second outer magnet 1032 may be arranged symmetrically with respect to the inner magnet 102. However, such three-magnet assembly is not necessary. For instance, one outer magnet or three, four or more outer magnets distributed around the inner magnet may be used. In an example, two or more inner magnets may also be used.

As an example, the outer magnet stopper 107 may abut against the outer magnet 103 in at least one direction, for example in x direction or y1, y2 direction shown in FIG. 1. As an example, the at least one outer magnet stopper 107 may also abut against the outer magnet 103 in at least two directions, for example in x direction and y1, y2 direction shown in FIG. 1.

In an embodiment, the at least one outer magnet 105 has at least one contacting face 113 abutting against the outer magnet stopper 107. For example, the contacting face 113 may be arranged at a corner of the outer magnet 103 on the side thereof towards the inner magnet 102 (referring to FIGS. 1-3). As an example, one or more of the contacting faces 113 may not directly face the inner magnet 102, in other words, may be angled to a first direction in a plane parallel to the magnet conductive base plate 101. The first direction is a direction towards the inner magnet 102 from the outer magnet 103 on which the one or more contacting faces 113 are located. In the embodiment shown in FIGS. 1-3, for the contacting faces 113 of the first outer magnet 1031, the first direction is the direction indicated by y1; for the contacting faces 113 of the second outer magnet 1032, the first direction is the direction indicated by y2. In an example, the angle between the contacting faces and the first direction may be in the range of 30 to 60 degrees, such as 45 degrees.

In an embodiment, the at least one contacting faces 113 may comprise a first contacting face 1131 and a second contacting face 1132. The first contacting face 1131 and the second contacting face 1132 may be arranged at two different corners of the same outer magnet 103 and not parallel to each other. As an example, the first contacting face 1131 and the second contacting face 1132 contact with the outer magnet stopper 107, respectively. By means of a combination of the first contacting face 1131 and the second contacting face 1132, it can not only prevent the outer magnet 103 from shifting towards the inner magnet 102, but also avoid the movement of the outer magnet 103 in its longitudinal direction.

In an embodiment, as shown in FIG. 4, the contacting face 113 may comprise a first contacting face 1133, 1135 and a second contacting face 1134, 1136. The first contacting face 1133, 1135 and the second contacting face 1134, 1136 may be arranged at the same corner of the same outer magnet 103 and not parallel to each other. As an example, the first contacting face 1133 and the second contacting face 1134 may abut against the same outer magnet stopper 107′. Or, the first contacting face 1135 and the second contacting face 1136 may abut against the different outer magnet stoppers 107a, 107b, respectively.

In an embodiment, the outer magnet stopper may also be arranged to abut against the outer magnet on the side of the outer magnet towards the inner magnet, for example, the outer magnet stopper 107c as shown in the upper part of FIG. 4. As an example, the at least one outer magnet stopper may be arranged at least partly in the space 106 between the inner magnet 102 and the at least one outer magnet 103.

Although FIGS. 1-4 illustrate various forms of the outer magnet stoppers, it should be understood that it is only illustrative, and any of the outer magnet stoppers may be used separately or in combination. One outer magnet may be stopped by one, two, three or more outer magnet stoppers. In the embodiments, the outer magnet stopper may have various shapes, for example, rectangle, cylinder, cone or truncated cone. As an example, the outer magnet stopper may be upright, that is, in substantially perpendicular to the magnet conductive base plate, or may be inclined to the normal of the magnet conductive base plate.

In an embodiment, the outer magnet stoppers and the magnet conductive base plate may be integrated in one single part. Or, the outer magnet stoppers may be connected to the magnet conductive base plate for example by welding or inserting.

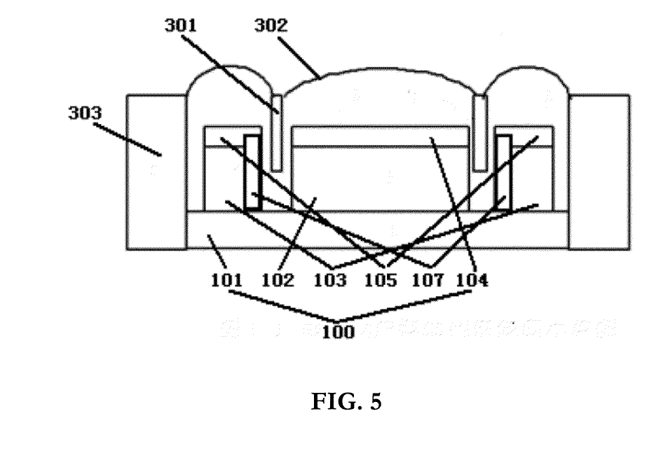

The present invention also relates to a speaker 300. As shown in FIG. 5, the speaker 300 includes the magnet assembly 100 according to any of the above embodiments, a coil 301, a vibration membrane 302 and a supporter 303. As describe above, the magnet assembly 100 includes components, such as the magnet conductive base plate 101, the inner magnet 102, the outer magnet 103, the inner magnet conductive plate 104 and the outer magnet conductive plate 105. As an example, the coil 301 is arranged in the space between the outer magnet 103 and the inner magnet 102 and surrounds the inner magnet 102. The vibration membrane 302 is laid on the coil 301 and above the inner magnet 102 and the outer magnet 103. The supporter 303 is connected to the magnet conductive base plate 101 and supports the vibration membrane 302.

For a speaker, the positional relationship between the inner magnet and the outer magnet is very critical. If the outer magnet becomes displaced with respect to the inner magnet from the desired design positions, it may cause enhanced distortion of signals or noises. The magnet assembly according to the above embodiments of the present invention may limit the positions of the outer magnets reliably so as to suppress the effects of such enhanced distortion of signals or noises.

Although the present invention has been explained with reference to Figures, the embodiments shown in Figures are only illustrative, not limiting to the present invention.

Although some embodiments of the general inventive concept are illustrated and explained, it would be appreciated by those skilled in the art that modifications and variations may be made in these embodiments without departing from the principles and spirit of the general inventive concept of the disclosure, the scope of which is defined in the appended claims and their equivalents.

What is claimed is:

1. A magnet assembly for a speaker, the assembly comprising:
a magnet conductive base plate;
an inner magnet arranged on the magnet conductive base;
at least one outer magnet arranged on the magnet conductive base and spaced apart from the inner magnet;
an inner magnet conductive plate arranged on the inner magnet;
at least one outer magnet conductive plate arranged on the at least one outer magnet; and
at least one outer magnet stopper arranged on the magnet conductive base plate, the at least one outer magnet stopper abutting against the at least one outer magnet to limit the displacement of the at least one outer magnet in at least two directions.

2. The magnet assembly according to claim 1 further comprising a first outer magnet and a second outer magnet arranged on opposite sides of the inner magnet, a first outer magnet conductive plate arranged on the first outer magnet and a second outer magnet conductive plate arranged on the second outer magnet.

3. The magnet assembly according to claim 2, wherein the first outer magnet and the second outer magnet are arranged symmetrically with respect to the inner magnet.

4. The magnet assembly according to claim 1, wherein the at least one outer magnet stopper is arranged at least partly in a space between the inner magnet and the at least one outer magnet.

5. The magnet assembly according to claim 1, wherein the at least one outer magnet stopper abuts against the outer magnet on one side of the outer magnet facing the inner magnet.

6. The magnet assembly according to claim 1, wherein the at least one outer magnet has at least one contacting face which abuts against the outer magnet stopper and is arranged at a corner of the outer magnet towards the inner magnet.

7. The magnet assembly according to claim 6, wherein the at least one contacting face is angled to a first direction in a plane parallel to the magnet conductive base plate, the first direction being a direction towards the inner magnet from the outer magnet on which the at least one contacting face is located.

8. The magnet assembly according to claim 6, wherein the at least one outer magnet comprises a first contacting face and a second contacting face arranged at two different corners of the same outer magnet and not parallel to each other, the first contacting face and the second contacting face abutting against the different outer magnet stoppers, respectively.

9. The magnet assembly according to claim 6, wherein the at least one contacting face comprises a first contacting face and a second contacting face arranged at the same corner of the same outer magnet and not parallel to each other, the first contacting face and the second contacting face abutting against the different outer magnet stoppers respectively or abutting against the same outer magnet stopper.

10. The magnet assembly according to claim 1, wherein the outer magnet stopper and the magnet conductive base plate are integrated in one single part.

11. A speaker, comprising:
A magnet assembly, the assembly comprising:
a magnet conductive base plate;
an inner magnet arranged on the magnet conductive base;
at least one outer magnet arranged on the magnet conductive base and spaced apart from the inner magnet;
an inner magnet conductive plate arranged on the inner magnet;
at least one outer magnet conductive plate arranged on the at least one outer magnet; and
at least one outer magnet stopper arranged on the magnet conductive base plate, the at least one outer magnet stopper abutting against the at least one outer magnet to limit the displacement of the at least one outer magnet in at least two directions; and
a coil arranged in the space between the outer magnet and the inner magnet and surrounding the inner magnet;
a vibration membrane laid on the coil and above the inner magnet and the outer magnet; and
a supporter connected to the magnet conductive base plate and configured to support the vibration membrane.
